(19) United States
(12) Patent Application Publication
(10) Pub. No.: US 2026/0284455 A1
(43) Pub. Date: Sep. 24, 2026

(54) BATTERY SYSTEM WITH FIRE EXTINGUISHING PUMP

(71) Applicant: SAMSUNG SDI CO., LTD., Yongin-si (KR)

(72) Inventor: Marton NEMES, Seiersberg-Pirka (AT)

(21) Appl. No.: 19/394,732

(22) Filed: Nov. 19, 2025

(30) Foreign Application Priority Data
Mar. 24, 2025 (EP) 25165727.6

(51) Int. Cl. A62C 35/02; A62C 3/07; A62C 3/16; A62C 35/13; H01M 10/42; H01M 50/383

(52) U.S. Cl. CPC A62C 35/026; A62C 3/07; A62C 3/16; A62C 35/13; H01M 10/4228; H01M 50/383; H01M 2220/20

(57) ABSTRACT

A battery system includes: a battery pack including a housing and a plurality of battery cells accommodated within the housing; and a fire extinguishing pump including: a chamber having a first portion and a second portion separated from each other by a movable barrier member between the first portion and the second portion; a fire extinguisher material in the first portion; an explosive material in the second portion; an outlet in the first portion of the chamber configured to release fire extinguisher material toward at least one of the battery cells; and an explosion trigger system configured to cause the explosive material to explode in response to venting gas being ejected from at least one of the battery cells to move the movable barrier member to push at least some of the fire extinguisher material through the outlet.

### CROSS-REFERENCE TO RELATED APPLICATION

The present application claims priority to European Patent Application No. 25165727.6, filed on Mar. 24, 2025, in the European Patent Office, the entire disclosure of which is incorporated herein by reference.

### BACKGROUND

### 1. Field

Aspects of embodiments of the present disclosure relate to a battery system with a fire extinguishing pump.

### 2. Description of the Related Art

A battery pack is a set of any number of (usually identical) battery modules or single battery cells. The battery modules, or respectively the battery cells, may be connected in series, parallel, or a mixture of both to provide the desired voltage, capacity, and/or power density. Components of a battery pack generally include the individual battery modules and interconnects, which provide electrical conductivity between the battery modules.

A battery system may also include a battery management system (BMS), which is any suitable electronic system that is configured to manage the rechargeable battery cell(s), battery module(s), and battery pack(s), such as by protecting the batteries from operating outside their safe operating area, monitoring their states, calculating secondary data, reporting that data, controlling its environment, authenticating it, and/or balancing it. For example, the BMS may monitor the state of the battery cell as represented by voltage (e.g., a total voltage of the battery pack or battery modules and/or voltages of individual battery cells), temperature (e.g., an average temperature of the battery pack or battery modules, coolant intake temperature, coolant output temperature, or temperatures of individual battery cells), coolant flow (e.g., flow rate and/or cooling liquid pressure), and current. Additionally, the BMS may calculate values based on the above characteristics or measured values, such as minimum and maximum cell voltage, state of charge (SOC) or depth of discharge (DOD) to indicate the charge level of the battery cell, state of health (SOH; a variously-defined measurement of the remaining capacity of the battery cell as a percent of the original capacity), state of power (SOP; the amount of power available for a defined time interval given the current power usage, temperature, and other conditions), state of safety (SOS), maximum charge current as a charge current limit (CCL), maximum discharge current as a discharge current limit (DCL), and internal impedance of a cell (to determine open circuit voltage).

The BMS may be centralized such that a single controller is connected to the battery cells through a multitude of wires. In other examples, the BMS may be distributed, with a BMS board is installed at each cell, with just a single communication cable between the battery cell and a controller. In yet other examples, the BMS may have a modular construction including a few controllers, each handling a certain number of (e.g., a group of) cells, while communicating between the controllers. Centralized BMSs are most economical but are least expandable and are plagued by a multitude of wires. Distributed BMSs are the most expensive but are simplest to install and offer the cleanest assembly. Modular BMSs provide a compromise of the benefits and problems of the other two topologies.

Exothermic decomposition of cell components may lead to a so-called thermal runaway. Generally, thermal runaway describes a process that accelerates due to increased temperature, in turn releasing energy that further increases temperature. Thermal runaway occurs in situations when an increase in temperature changes cell conditions in a way that causes a further increase in temperature, often leading to a destructive result. In rechargeable battery systems, thermal runaway is associated with strong exothermic reactions that are accelerated by temperature rise. In thermal runaway, the battery cell temperature rises incredibly fast, and the energy stored is released very suddenly. In extreme cases, thermal runaway can cause battery cells to explode and start a fire. In minor cases, it can cause battery cells to be damaged beyond repair.

When a battery cell is heated above a critical temperature (e.g., above about 150° C.) the battery cell can transition into a thermal runaway. Generally, temperatures outside of the safe region on either the low or high side may lead to irreversible damage to the battery cell and, therefore, may possibly trigger thermal runaway. Thermal runaway may also occur due to an internal or external short circuit of the battery cell or poor battery maintenance. For example, overcharging or rapid charging may lead to thermal runaway.

During thermal runaway, the failed battery cell may reach a temperature exceeding about 700° C. Further, large quantities of hot gas are ejected from inside of the failed battery cell through a venting opening in the cell housing into the battery pack. The main components of the vented gas are H₂, CO₂, CO, electrolyte vapor, and other hydrocarbons. The vented gas is therefore flammable and potentially toxic. The vented gas also causes the gas-pressure to increase inside the battery pack. In the worst case, the high temperatures lead to the process (e.g., the thermal runaway) spreading to neighboring cells and a fire throughout the battery pack. At this stage, the fire is difficult to extinguish.

The BMS is critical to the safe operation and optimal performance of rechargeable battery cells and helps reduce or minimize the possibility of thermal runaway. For example, if the BMS detects that the temperature is too high, it can regulate the temperature by controlling cooling fans. Alternatively, if the battery cell cannot be cooled and safe conditions restored, the BMS may shut down necessary battery cells to protect the entire system.

### SUMMARY

Further solutions for reacting to thermal runaway events in a battery cell to prevent spreading to adjacent battery cells and to effectively extinguish a fire with a fast response time are needed. In addition, a battery system that works more effectively, for example, which does not need additional computational resources that may drag on processor's load of the BMS or other control units and/or requires additional electrical wiring or which may extinguish locally distinct battery cells are desired.

The present disclosure is defined by the appended claims and their equivalents. The description that follows is subject to this limitation. Any disclosure lying outside the scope of the claims and their equivalents is intended for illustrative as well as comparative purposes.

According to one embodiment of the present disclosure, a battery system includes a battery pack including a housing and a plurality of battery cells accommodated within the housing. The battery system further includes a fire extinguishing pump. The fire extinguishing pump includes a chamber having a first portion and a second portion separated from each other by a movable barrier member between the first portion and the second portion. A fire extinguisher material is provided in the first portion, and an explosive material is provided in the second portion. An outlet is provided in the first portion of the chamber to release fire extinguisher material toward at least one of the battery cells or a proximity thereof. The battery system further includes an explosion trigger system configured to cause the explosive material to explode in response to venting gas being ejected from at least one of the battery cells to move the movable barrier member to push at least some of the fire extinguisher material through the outlet.

According to another embodiment of the present disclosure, a method for operating a battery system includes providing the battery system as described above and causing the explosive material to explode in response to the venting gas being ejected from at least one of the battery cells to move the movable barrier member to push at least some of the fire extinguisher material through the outlet toward at least one of the battery cells.

Another embodiment of the present disclosure provides a vehicle including the battery system as described above.

Further aspects and features of the present disclosure can be learned from the dependent claims or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a block diagram describing a battery system according to an embodiment;

FIG. 2 is a schematic cross-sectional view of a fire extinguishing pump according to an embodiment;

FIG. 3 is a schematic top view of a battery system according to an embodiment;

FIG. 4 is a schematic top view of a battery system according to another embodiment;

FIG. 5 is a schematic top view of a battery system according to another embodiment;

FIG. 6 is a schematic top view of a battery system according to another embodiment;

FIG. 7 is a schematic top view of a battery system according to another embodiment;

FIG. 8 is a schematic top view of a battery system according to another embodiment; and

FIG. 9 is a block diagram describing a method of operating a battery system according to an embodiment.

### DETAILED DESCRIPTION OF THE INVENTION

Reference will now be made, in detail, to embodiments, examples of which are illustrated in the accompanying drawings. Aspects and features of the embodiments, and implementation methods thereof, will be described with reference to the accompanying drawings. The present disclosure, however, may be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

As used herein, the term “and/or” includes any and all combinations of one or more of the associated listed items. Further, the use of “may” when describing embodiments of the present disclosure refers to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be further understood that the terms “include,” “comprise,” “including,” or “comprising” specify a property, a region, a fixed number, a step, a process, an element, a component, and a combination thereof but do not exclude other properties, regions, fixed numbers, steps, processes, elements, components, and combinations thereof.

Herein, the terms “upper” and “lower” are defined according to the z-axis. For example, the upper cover is positioned at the upper part of the z-axis, and the lower cover is positioned at the lower part thereof. In the drawings, the sizes of elements may be exaggerated for clarity. For example, in the drawings, the size or thickness of each element may be arbitrarily shown for illustrative purposes, and thus the embodiments of the present disclosure should not be construed as being limited thereto. The same reference numerals designate the same elements.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

The electronic or electric devices and/or any other relevant devices or components according to embodiments of the present disclosure described herein may be implemented utilizing any suitable hardware, firmware (e.g., an application-specific integrated circuit), software, or a combination of software, firmware, and hardware. Further, the various components of these devices may be implemented on a flexible printed circuit film, a tape carrier package (TCP), a printed circuit board (PCB), or formed on one substrate. The electrical connections or interconnections described herein may be realized by wires or conducting elements, for example, on a PCB or another kind of circuit carrier. The conducting elements may include metallization, for example, surface metallizations and/or pins, and/or may include conductive polymers or ceramics. Further electrical energy might be transmitted via wireless connections, for example, by using electromagnetic radiation and/or light.

Also, a person of skill in the art should recognize that the functionality of various computing devices may be combined or integrated into a single computing device, or the functionality of a particular computing device may be distributed across one or more other computing devices without departing from the scope of the exemplary embodiments of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

According to one embodiment of the present disclosure, a battery system includes a battery pack including a housing and a plurality of battery cells accommodated within the housing. The battery system further includes a fire extinguishing pump. The fire extinguishing pump has a chamber, for example, a casing, having a first portion and a second portion separated from each other by a movable barrier member between the first portion and the second portion. A fire extinguisher material is provided in the first portion, and an explosive material in the second portion. An outlet, for example, a release opening, is provided in the first portion of the chamber to release fire extinguisher material toward at least one of the battery cells. The battery system further includes an explosion trigger system configured to cause the explosive material to explode in response to venting gas being ejected from at least one of the battery cells to move the movable barrier member to push at least some of the fire extinguisher material through the outlet.

The fire extinguishing pump may be, for example, a fire extinguishing unit or device. The explosive material may be a propellant material. The movable barrier member may be a movable piston member or another pressure transfer member. The first portion and/or the second portion may be regarded as sub-chambers of the chamber. The first portion may be a tank for storing the extinguisher material. The chamber may be, for example, a casing. The extinguisher material may be a liquid, such ash water or a solution with non-flammable chemical agent solved in the liquid, or a fire extinguisher foam. The explosive material is not limited to particular examples and any suitable materials that can explode in a controlled manner rapidly to shoot out the extinguishing material in direction of the battery cells may be used.

The battery system increases operation safety of the battery pack by providing an explosion trigger system that rapidly reacts in response to venting gas being ejected from at least one of the battery cells, for example, in a thermal runaway or in a precursor thereof, to perform a controlled explosion of the explosive material, which causes the extinguisher material to be released to the battery cells due the movement of the movable barrier member. Thus, the battery system responds fast when venting gas due to a possible thermal runaway event of at least one battery cell occurs. The system transports (or moves) the fire extinguisher material (FEM) to the burning battery cells or at least to the proximity of it to extinguish the burning battery cell. Therefore, an effective fire extinguisher for a burning battery cell is provided.

According to another embodiment, the explosion trigger system is configured to cause the explosive material of the fire extinguishing pump to explode through venting gas ejected from at least one of the battery cells in the thermal runaway event. For example, the venting gas (ejected through venting valves of the battery cells) is used as the trigger material to cause the explosion. The explosion event is, therefore, directly related to or directly caused by the ejecting of the venting gas. The venting gas has very high temperatures and causes high pressure in the housing. These changes in properties can be directly used to cause the explosion without requiring any separate detection, such as additional sensors, or any active controllers, such as a battery management system (BMS). Therefore, due to the direct use of venting gas as the trigger material for the explosion, the explosion trigger system can, automatically and without additional controllers or sensors, very quickly respond to a fire in a battery cell due to thermal runaway to thereby rapidly extinguish the fire with minimum loss in time. The battery system, therefore, does not need additional computational resources or additional sensors, thereby reducing electronic circuitry and avoiding additional drag on processor's load of the BMS or other control units.

According to another embodiment, the chamber has an opening in the second portion. The opening has a coupling function, for example, the interaction of the venting gas with the explosive material is facilitated via the opening so that the sensitivity can be improved. The opening allows for close contact of the explosive material with the venting gas to trigger the explosion more quickly and a shielding due to the chamber may be at least reduced.

According to another embodiment, the fire extinguishing pump is positioned at a venting gas outlet of the housing so that venting gas discharged through the venting gas outlet causes the explosive material to explode. Most battery packs have a venting gas outlet where the venting gas is concentrated and outputted in concentrated from. Thus, positioning the fire extinguishing pump at the venting gas outlet increases the interaction of the venting gas with the explosive material. Thus, a faster response and explosion to extinguish the burn can be achieved and sensitivity of the extinguisher pump is improved.

According to another embodiment, the fire extinguishing pump is positioned in a dedicated position in a venting gas stream in the housing so that venting gas causes the explosive material to explode. Thus, the fire extinguishing pump can also be integrated in the housing so that the interaction distance to the battery cells is reduced, which may cause a faster response time. The positioning in the housing at dedicated position may be, again, in proximity to the venting outlet or at other positions where the venting gas is determined or expected to have higher concentration due to guiding elements or by having a streaming profile (or flow path) designed in the housing.

According to another embodiment, the explosion trigger system includes at least one venting pipe (e.g., a venting pipe structure) extending from at least one of the plurality of battery cells to the fire extinguishing pump so that venting gases released from the at least one battery cell are transported to the fire extinguishing pump to cause the explosive material to explode. This allows that venting gases from various locations of the battery pack to be directed through the venting pipes toward the fire extinguishing pump. This may optimize the interaction of the venting gas directly with the fire extinguishing pump to reduce reaction times, for example, during a thermal runaway event.

According to another embodiment, the explosion trigger system includes at least a pyrotechnical fuse (e.g., a pyrotechnical fuse structure) extending from at least one of the plurality of battery cells or a venting gas outlet of the housing to the fire extinguishing pump so that the venting gas causes a burning of the pyrotechnical fuse, which propagates along the pyrotechnical fuse to the fire extinguishing pump to cause the explosive material to explode. Thus, in this embodiment, the venting gases are used to ignite the pyrotechnical fuse, which then propagates to the extinguishing pump to cause the required explosion of the explosive material to achieve the extinguishment response. With the pyrotechnical fuse, one can reach very close to the battery cells so that the occurrence of venting gas is transferred fast with high likelihood. The pyrotechnical fuse may be, in other words, an explosion fuse.

According to another embodiment, at least a portion of the pyrotechnical fuse or at least one opening of the venting pipe extends to a location above at least one venting valve of a corresponding battery cell. Thus, from each battery cell, locally, burning can be readily transferred to the extinguishment system and an early extinguishing response on venting gas ejection and/or thermal runaway can be achieved.

According to another embodiment, the explosion trigger system includes a mechanical pressure cartridge provided in the housing and includes a movable member actuated by a pressure being above a reference (or threshold) pressure inside the housing and a spark generator. The movable member is configured to mechanically actuate the spark generator to cause the explosive material to explode. Thus, in this embodiment, the increase in pressure due to release in venting gases is used to cause the explosion of the explosive material. The spark generator may be a piezo element. No additional detectors or control units are needed in this embodiment of the present disclosure. Also, the venting gas is directly used in terms of the pressure increase caused by the ejected venting gas.

According to another embodiment, the fire extinguishing pump includes a burst plate located at the outlet to contain the fire extinguisher material in the chamber. The burst plate is configured to open (e.g., to burst or tear) in response to being pressed by (e.g., an increase in pressure of) the fire extinguisher material. Thus, the fire extinguisher material, before being activated by the venting gas, can be safely contained in the chamber before activation due the explosion caused by the venting gas and/or the thermal runaway. The burst plate may be, in other words, a burst element.

According to another embodiment, the outlet of the fire extinguishing pump is open to an interior of the housing so that the housing is at least partially flooded by the extinguisher material in response to the venting gas ejection and/or thermal runaway event. This prevents a spreading of thermal runaway to other battery cells because also neighboring battery cells are extinguished so that a spread that may have occurred during reaction time may be prevented. In this embodiment, the fire extinguishing pump is placed in the housing.

According to another embodiment, the battery system includes a transport pipe system including a plurality of transport pipes connected to the outlet and extending to the plurality of battery cells so that fire extinguisher material is supplied through the plurality of transport pipes to the plurality of battery cells in response to venting gas being ejected and/or a thermal runaway event. This allows the fire extinguishing material to be directed to particular spots where extinguishing may be most efficient. Thus, increase of efficiency in extinguishing of fire and/or thermal runaway is achieved.

According to another embodiment, the transport pipe system includes a main supply transport pipe connected to the outlet and a plurality of branched transport pipes, which are connected to and branch off from the main supply transport pipe to extend along a stack of at least one battery cell. This provides an efficient transport pipe network to deliver the fire extinguishing material to the battery cell rows of a battery pack.

According to another embodiment of the present disclosure, the explosion trigger system includes at least one sensor for detecting venting gas being ejected and/or a thermal runaway of at least one of the battery cells, and the at least one control unit is configured to cause the explosive material to explode by an electrical signal in response to sensing, by the at least one sensor, venting gas being ejected and/or a thermal runaway of at least one battery cell. In this embodiment, an electric signal is used to cause the explosion.

According to another embodiment, the transport pipe system includes a plurality of branched transport pipes including the release openings corresponding to at least one battery cell and branched from a main transport pipe that is connected to the outlet. In addition, the transport pipe system includes a plurality of valves, each provided in respective branched transport pipes. The battery system further includes a plurality of sensors, each associated with one or a subset from among the plurality of battery cells. The battery system includes at least one control unit (e.g., controller) configured to detect venting gas being ejected and/or a thermal runaway through at least one from among the plurality of sensors; identify the branched transport pipe associated to at least one sensor detecting venting gas being ejected and/or a thermal runaway, and control the plurality of valves so that the fire extinguisher material is transported to the identified transport pipe. Thus, unnecessary waste of fire extinguisher material is avoided while ensuring that reasonable amounts of fire extinguisher material can be supplied to the location which requires most extinguishing action so that efficiency in the extinguishing operation is improved. The sensor may be a temperature sensor to probe (or measure) the local temperature environment of battery cells individually for sensing thermal runaway or venting gas ejection cell-resolved.

According to another embodiment of the present disclosure, a method for operating a battery system is provided including providing a battery system as described above and causing the explosive material to explode in response to venting gas ejected from at least one of the battery cells to move the movable barrier member to push at least some of the fire extinguisher material through the outlet toward at least one of the battery cells. The method may further include further steps as described above in the context of the battery system.

Yet another embodiment of the present disclosure provides a vehicle including the battery system as described above.

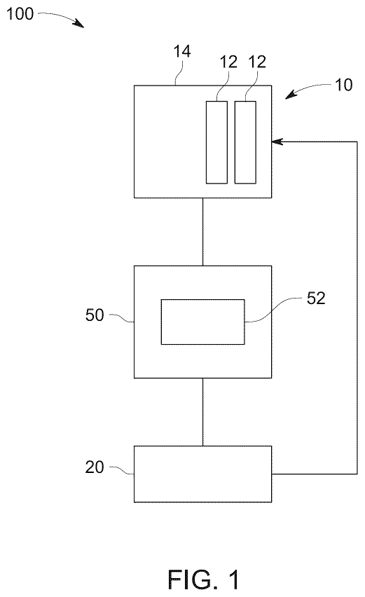

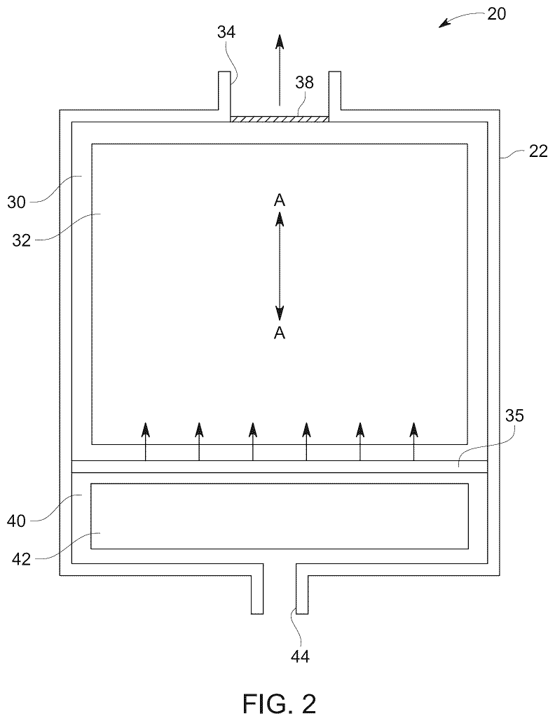

FIG. 1 is a block diagram describing a battery system according to an embodiment. FIG. 2 is a schematic cross-sectional view of a fire extinguishing pump according to an embodiment.

With reference to FIG. 1 and FIG. 2, a battery system 100 and a fire extinguishing pump 20 are described according to an embodiment of the present disclosure.

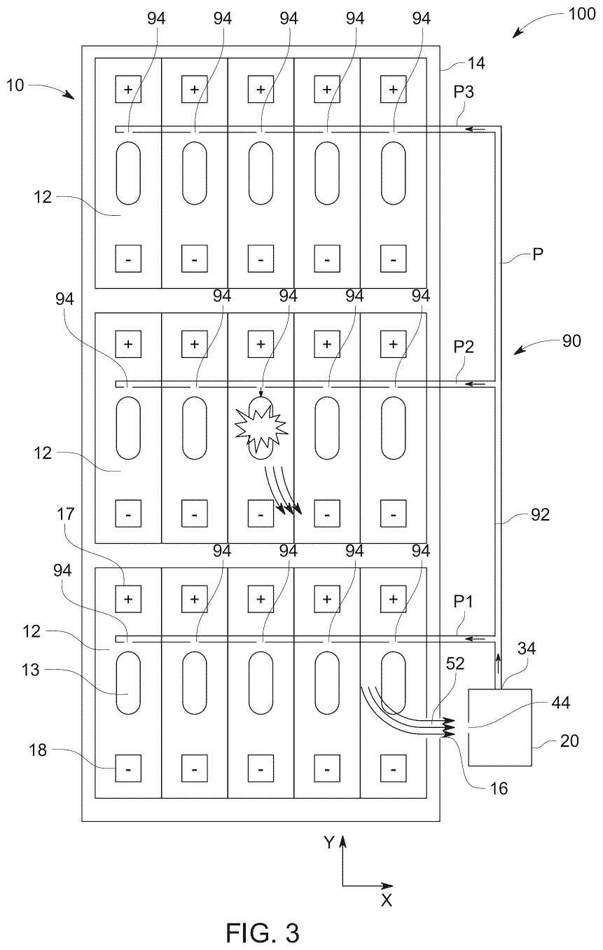

As schematically shown in FIG. 1, or in the various embodiments as described with reference to FIG. 3 to FIG. 9, the battery system 100 includes a battery pack 10. The battery pack 10 includes a plurality of battery cells 12 accommodated within a housing 14. Each battery cell 12, as shown in, for example, FIG. 3 to FIG. 9, includes a positive terminal 17 and a negative terminal 18. The battery pack 10 may include one or more battery modules including a subset of battery cells 12 stacked together in a row. At least one of the battery cells 12 may undergo thermal runaway and/or may eject (or emit) venting gas, which may set the battery cell 12 on fire and/or may spread in the battery pack 10 from battery cell to battery cell.

To extinguish the fire and/or to prevent the spread of thermal runaway, the battery system 100 includes a fire extinguishing pump 20 schematically shown in FIG. 1. The fire extinguishing pump 20 is explained in more detail below with reference to FIG. 2.

The fire extinguishing pump 20 includes a chamber 22. The chamber 22 forms a housing or a container. The chamber 22 has a first portion 30 and a second portion 40. The two portions 30 and 40 are separated by a movable barrier member 35. The movable barrier member 35 divides the chamber 22 into the first portion 30 and the second portion 40. The movable barrier member 35 may be movable in an axial direction A of the chamber 22. When the movable barrier member 35 moves in the axial direction A, a volume of the first portion 30 is reduced and, concurrently, a volume of the second portion 40 is increased. The movable barrier member 35 may be a pressure transfer element, such as a piston member. A fire extinguisher material 32 is provided in the first portion 30 of the chamber 22. For example, the fire extinguisher material 32 may be a liquid, such as water, a water-solution including anti-flammable agents, or an extinguisher foam material, but the present disclosure is not limited thereto. An explosive material 42, such as an explosive or propellant material, is provided in the second portion 40. The explosive material 42 may be an explosive powder material but the present disclosure is not limited thereto.

Further, as shown in FIG. 2, the chamber 22 includes an outlet 34. The outlet 34 is located in (e.g., is in fluid communication with) the first portion 30 of the chamber 22. Thus, the fire extinguisher material 32 can be released (e.g., ejected or pushed) through the outlet 34 toward at least one of the battery cells 12 of the battery pack 10 or at least to a proximity thereof. This will be described in more detail below.

For the fire extinguisher material 32 to be ejected out through the outlet 34 (and toward the battery cells 12, that is, into the housing 14) the battery system 100 further includes an explosion trigger system 50. The explosion trigger system 50 is configured to cause the explosive material 42 to explode in response to venting gas being ejected from and/or a thermal runaway of at least one of the battery cells 12. In turn, the explosion of the explosive material 42 (and the pressure increase or volume expansion) causes the movable barrier member 35 to be moved in the direction of (e.g., to be moved toward) the outlet 34, thereby reducing the volume of the first portion 30. Thus, the movable barrier member 35 pushes, by its movement, at least some of the fire extinguisher material 32 through the outlet 34 in response to venting gas being ejected from at least one of the battery cells 12.

Therefore, a fire in one or more battery cells 12 can be effectively extinguished by the fire extinguishing pump 20 triggered by the explosion trigger system 50 as shown in, for example, FIG. 1. Thus, the explosion trigger system 50 causes the explosive material 42 of the fire extinguishing pump 20 to explode in response to venting gas 52 being ejected from at least one of the battery cells 12.

Due to the direct use of venting gas 52 as an explosion trigger medium, the explosion trigger system 50 can quickly respond to a fire in a battery cell due to thermal runaway to rapidly extinguish the fire with minimum loss in time. The battery system 100, therefore, does not need additional computational resources or additional sensors, thereby reducing the electronic circuitry and avoiding additional drag on processor's load of a battery management system (BMS) or other control units. Thus, the explosion event is therefore directly related to the ejecting of the venting gas 52, for example, in a thermal runaway event, without requiring any separate detection, such as additional sensors or any active controllers, like the BMS. The fire extinguishing pump 20 can, automatically and without additional controllers or sensors, very quickly respond to a fire in a battery cell due venting gas being ejected and/or a thermal runaway to thereby rapidly extinguish the fire with minimum loss in time.

Referring to FIG. 2, the chamber 22 has an opening 44 in the second portion 40. The opening 44 may prevent the explosive material 42 and the venting gas 52 as the explosion trigger medium from being shielded by the chamber walls (e.g., may place the explosive material 42 in fluid communication with outside of the chamber 22). This also allows faster reaction and a faster explosion response can be achieved due to allowing better contact with the venting gas 52.

As indicated in FIG. 2, the fire extinguishing pump 20 includes a burst plate 38 located at the outlet 34. This ensures that, in a non-activated state (the state without thermal runaway), the fire extinguisher material 32 is contained in the chamber 22, that is, it is secured from leaking. The burst plate 38 is configured to open (or burst) in response to being pressed by the fire extinguisher material 32 in an event of venting gas being ejected and/or a thermal runaway as described above. This is caused by the explosion and the response movement of the fire extinguisher material 32.

In an embodiment, the outlet 34 is open to an interior of the housing 14. Thus, the housing 14 is at least partially flooded by the fire extinguisher material 32 in response to an event of venting gas being ejected and/or a thermal runaway. In such embodiment, a rapidly spreading of thermal runaway may be prevented because the extinguishing reaction also includes the neighboring battery cells. The fire extinguishing pump 20 can be installed in the various embodiments as alternatives to the embodiments described with reference to FIG. 3 to FIG. 8 as described below.

FIG. 3 is a schematic top view of a battery system 100 according to an embodiment.

According to the embodiment shown in FIG. 3, the fire extinguishing pump 20 is positioned at a position to optimize interaction with the venting gas 52 as the trigger medium to provide faster response time. As shown in FIG. 3, the fire extinguishing pump 20 is positioned at a venting gas outlet 16 of the housing 14. Thus, the venting gas 52 discharged through the venting gas outlet 16 causes the explosive material 42 to explode. Therefore, due to the positioning of the fire extinguishing pump 20, the interaction with the venting gas 52 is increased because the venting gas 52 is concentrated at the venting gas outlet 16. In this way, the venting gas 52 can directly cause the explosion of the explosive material 42 to trigger the response of ejecting the extinguisher material 32 to extinguish the fire.

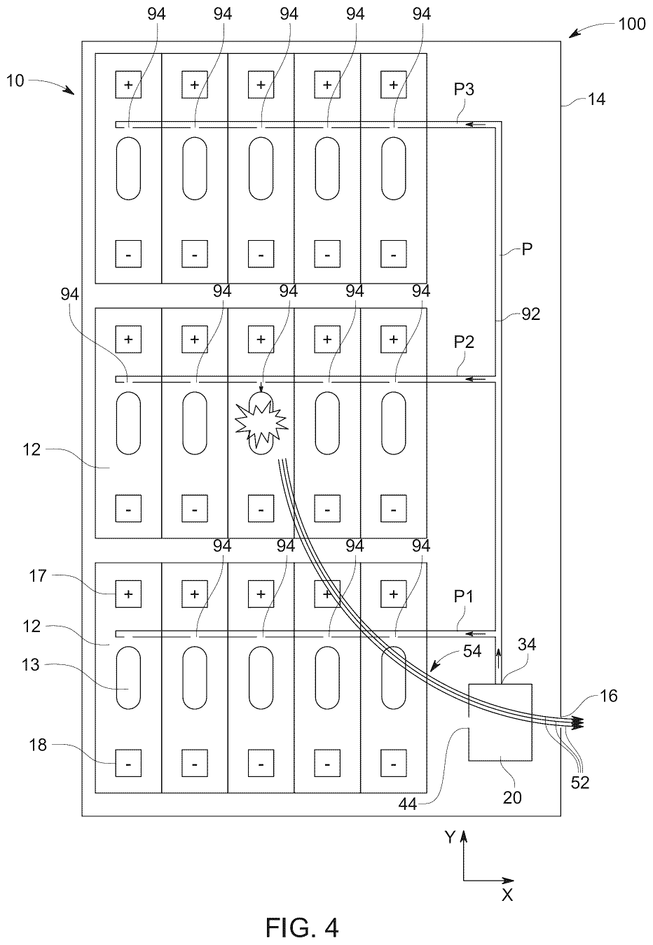

According to the embodiment shown in FIG. 3, the battery system 100 may include a transport pipe system 90 with a plurality of transport pipes 92 connected to the outlet 34. The transport pipes 92 extend to the plurality of battery cells 12 so that fire extinguisher material 32 is supplied through the plurality of transport pipes 92 to the plurality of battery cells 12 in response to an event of venting gas being ejected and/or a thermal runaway. Release openings 94 may be provided in the transport pipes 92, which correspond to respective battery cells 12. Thus, the fire extinguisher material 32 may be released locally and at locations where the battery cells 12 are located which. This feature can be implemented in any of the embodiments described with reference to FIG. 4 to FIG. 8.

In the present embodiment, the transport pipe system 90 includes a main supply transport pipe P connected to the outlet 34 and a plurality of branched transport pipes P1, P2, P3, which are connected to and branched off from the main supply transport pipe P to extend along a respective stack of at least one battery cell 12. This efficiently provides a transport pipe network to deliver the fire extinguisher material 32 to the battery cell rows of a battery pack 10. The branched transport pipes P1, P2, P3 include the release openings 94.

FIG. 4 is a schematic top view of a battery system 100 according to another embodiment. The differences with respect to the embodiment shown in FIG. 3 are primarily described in the following. According to the embodiment shown in FIG. 4, the fire extinguishing pump 20 is positioned at a position (e.g., a dedicated position) to optimize interaction with the venting gas 52 as the trigger medium according to another embodiment.

In this embodiment, the fire extinguishing pump 20 is positioned in a dedicated position inside the housing 14. The dedicated position is a location where a venting gas stream 54 is formed in case of venting gas being ejected and/or a thermal runaway event. Thus, the venting gas 52 of the venting gas stream 54 causes the explosion of the explosive material 42 to trigger the response of ejecting the fire extinguisher material 32 to extinguish the fire. The positioning in the housing 14 may be, as shown, in proximity to the venting gas outlet 16 or at other positions where the venting gas 52 will have a higher concentration.

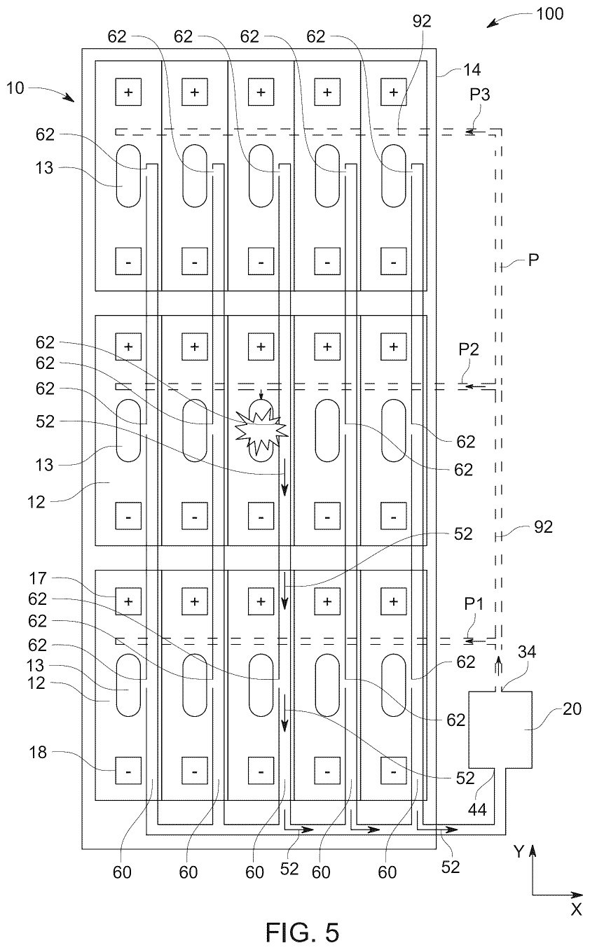

FIG. 5 is a schematic top view of a battery system 100 according to another embodiment. The differences with respect to the embodiments shown in FIG. 3 and FIG. 4 are primarily described in the following.

In this embodiment, the explosion trigger system 50 includes at least one venting pipe (e.g., venting pipe structure) 60. The at least one venting pipe 60 extends from at least one of the plurality of battery cells 12 to the fire extinguishing pump 20. The venting pipes 60 include at least one opening 62. The openings 62 are provided so that venting gases 52 released from the at least one battery cell 12 are transported into and through the venting pipes 60 to the fire extinguishing pump 20. Thus, the transported venting gas 52 can be directed to the fire extinguishing pump 20 to trigger the explosion reaction of the explosive material 42 to extinguish the burn of the at least one battery cell 12.

The venting pipe 60 may extend to a location so that the opening 62 is above (e.g., in the vicinity of) a venting valve 13, where the venting gas 52 is released from, of a corresponding battery cell 12. Thus, the entry of venting gas 52 into the venting pipe 60 is optimized. As shown in FIG. 5, each venting pipe 60 may include a plurality of openings 62 each associated with a battery cell 12 of the battery pack 10. The venting pipes 60 can direct the venting gas 52 directly to the location of where the fire extinguishing pump 20 is located.

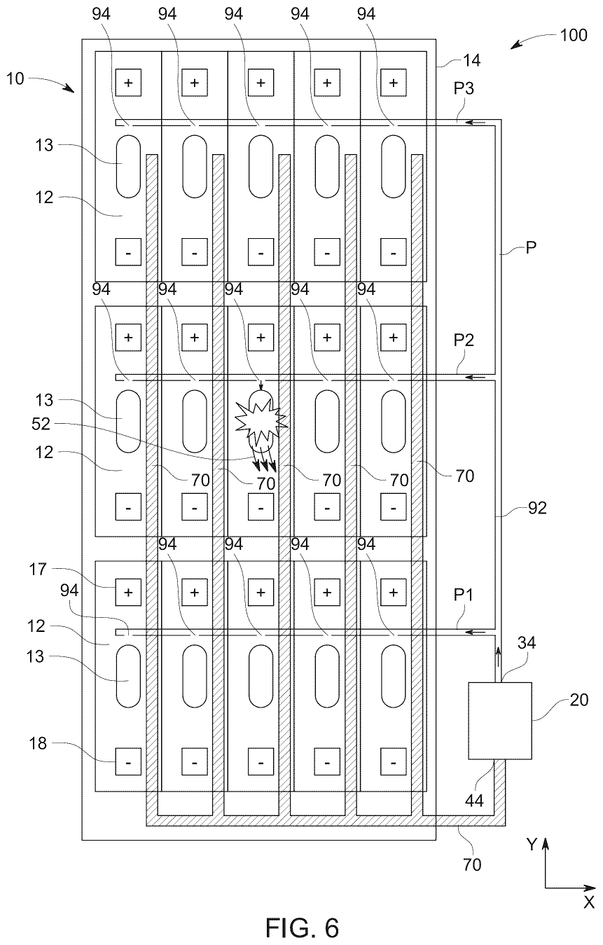

FIG. 6 is a schematic top view of a battery system 100 according to another embodiment. The differences with respect to the above-described embodiments are primarily described in the following.

The explosion trigger system 50 includes at least one pyrotechnical fuse 70 (or fuse structure). The at least one pyrotechnical fuse 70 extends from at least one of the plurality of battery cells 12 to the fire extinguishing pump 20. Thus, the venting gas 52 released from the battery cell 12 causes a burning of the at least one pyrotechnical fuse 70, which propagates along to the fire extinguishing pump 20. Thus, the pyrotechnical fuse 70 acts like a transmitter initiated by the venting gas 52 to cause the explosive material 42 to explode. This embodiment can be easily set up and rearranged, and the pyrotechnical fuse 70 can be placed close to the battery cells.

Also in this embodiment, the pyrotechnical fuse 70 extends to a location above (e.g., overlapping or in the vicinity of) at least one venting valve 13 of a corresponding battery cell 12. Thus, the venting gases 52, once released from the battery cell 12, can directly transfer the heat to the pyrotechnical fuse 70 so that the pyrotechnical fuse 70 burns toward the explosive material 42 to cause the explosion.

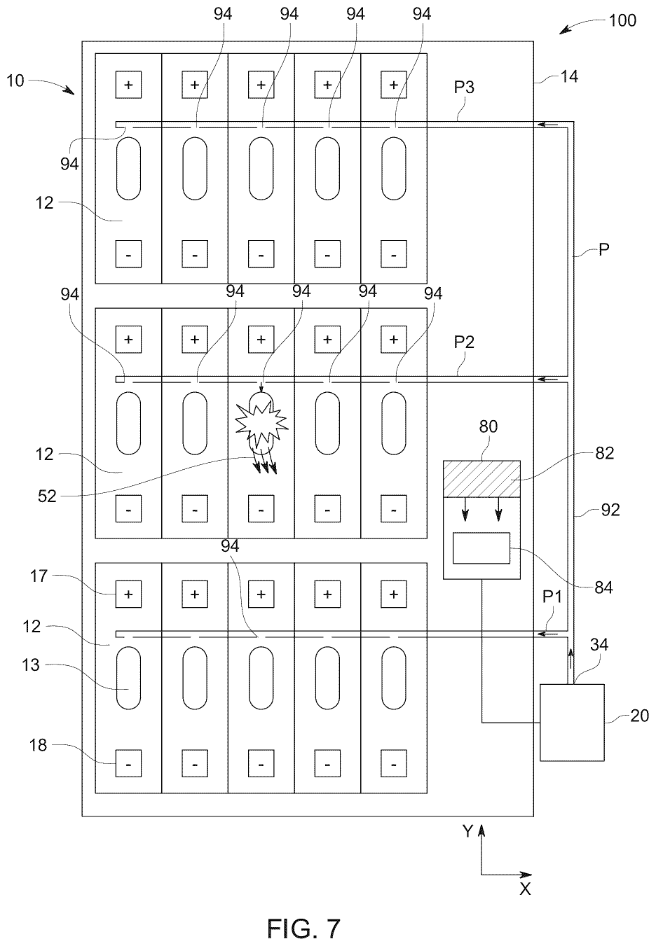

FIG. 7 is a schematic top view of a battery system 100 according to another embodiment. According to this embodiment, a mechanical pressure cartridge 80 is provided inside the housing 14. The mechanical pressure cartridge includes a movable member 82, for example, a piston member. In case of venting gas being ejected from and/or a thermal runaway of at least one of the battery cells 12, due the venting gases 52, the pressure inside the housing 14 rises. The movable member 82 may be actuated by the gas pressure being above a reference (or threshold) pressure inside the housing 14. The mechanical pressure cartridge 80 may further include a spark generator 84, such as a piezo element. In this embodiment, the movable member 82 is configured to mechanically actuate the spark generator 84. Thus, the spark may then cause the explosive material 42 to explode, thereby providing the effect of fire extinguishment directly initiated and caused by the ejected venting gas 52.

The above-described embodiments can be combined with one another. That means, the different mechanisms to trigger the explosions and arrangement thereof may be combined to increase safety thereby providing redundancy in the system.

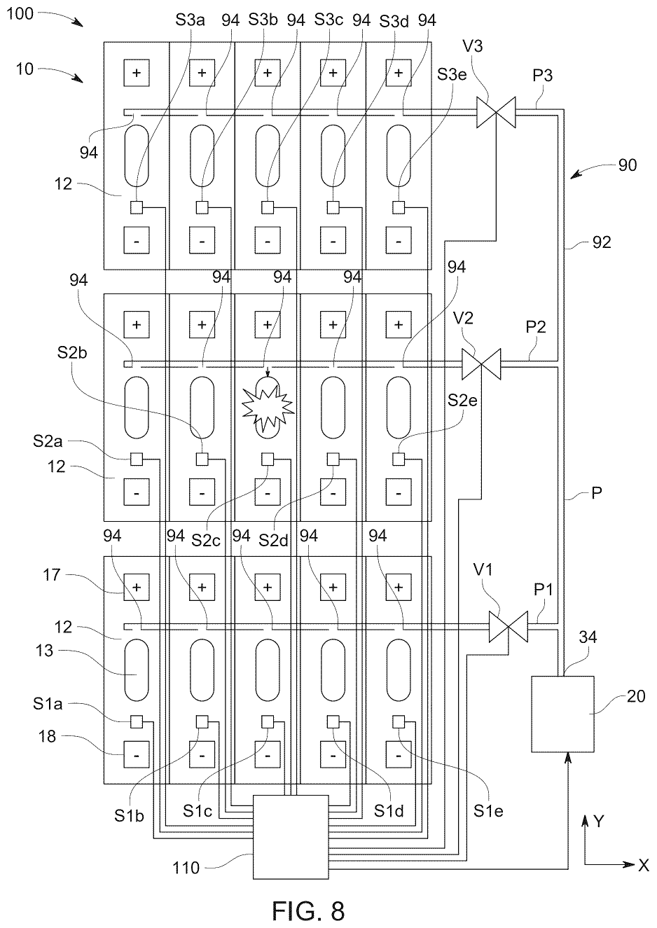

FIG. 8 is a schematic top view of a battery system 100 according to another embodiment. The present embodiment includes the battery system 100 that can localize the battery cell 12 experiencing venting gas being ejected thereof and/or a thermal runaway. The differences with respect to the previous embodiment shown in FIG. 3 will be primarily described in the following.

In this embodiment, the transport pipe system 90 includes a plurality of valves V1, V2, V3, each respectively provided in one of the branched transport pipes P1, P2, P3. A plurality of sensors S1a, . . . , S1e; S2a, . . . , S2e; S3a, . . . , S3e are each associated with one or a subset from among the plurality of battery cells 12. In addition, each of the plurality of sensor S1a, . . . , S1e; S2a, . . . , S2e; S3a, . . . , S3e is associated with a battery cell 12 of a corresponding row. In other embodiments, to reduce the number of sensors and wirings, only one sensor, such as S1, S2 and S3, may be provided for each row of battery cells. The sensors may be temperature sensors to probe the local temperature environment of each battery cell or of one row thereof (battery stack).

This embodiment further includes at least one control unit (e.g., controller) 110. The at least one control unit 110 monitors (e.g., controls) the sensors S1a, . . . , S1e; S2a, . . . , S2e; S3a, . . . , S3e to detect venting gas being ejected from and/or a thermal runaway of at least one of the respective battery cells 12.

The at least one control unit 110 in this embodiment is configured to cause the explosive material to explode by an electrical signal in response to sensing, through at least one sensor, venting gas being ejected from and/or a thermal runaway of at least one battery cell 12.

In the present embodiment, the at least one control unit 110 may identify the branched transport pipe P1, P2, P3 associated to at least sensor S1a, . . . , S1e; S2a, . . . , S2e; S3a, . . . , S3e that has detected venting gas being ejected and/or a thermal runaway. For example, for the identification, the inputs of the at least one control unit 110 may be used as the inputs correspond to the respective sensors so that a detection of venting gas being ejected from and/or a thermal runaway of a received sensor signal through an respective input terminal can be associated with, that is, linked to, a particular sensor S1a, . . . , S1e; S2a, . . . , S2e; S3a, . . . , S3e. Based on this information, the at least one control unit 110 can determine the branched transport pipe P1, P2, P3 (and/or the affected battery cell) to which the at least one sensor is associated to. In the illustrated example, the specific sensor S2c (see, e.g., FIG. 8) may be recognized as the sensor that has detected venting gas being ejected from and/or a thermal runaway. Thus, the second branched transport pipe P2 associated with the burned battery cell S2c may be identified.

In response to the detection, the at least one control unit 110 may control the plurality of valves V1, V2, V3 so that the fire extinguisher material 32 is transported, for example, pushed, to the identified transport pipe P1, P2, P3. For example, the valve belonging to the identified transport pipe is opened (e.g., moved or placed in an opened state) while the other valves are closed (e.g., moved or remain in a closed state). In the illustrated example, valve V1 and V3 remain closed and V2 is opened. Thus, the fire extinguisher material 32 is supplied in a targeted manner to the spot where the venting gas is ejected and/or a thermal runaway has occurred to increase efficiency. This avoids an unnecessary waste of fire extinguisher material 32 and ensures that reasonable amounts of fire extinguisher material (FEM) can be supplied to the location which requires most extinguishing actions.

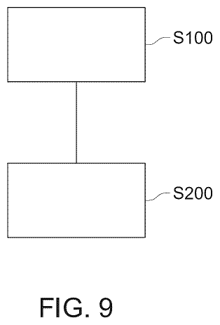

FIG. 9 is a block diagram describing a method of operating a battery system according to an embodiment.

The method includes the step of providing S100 a battery system 100 as described in one of the above-described embodiments.

The method further includes the step of causing S200 the explosive material 42 to explode to move the movable barrier member 35, thereby pushing at least some of the fire extinguisher material 32 through the outlet 34 toward at least one of the battery cells 12 in response to venting gas ejected from at least one of the battery cells 12. Further method steps follow from the various above-described embodiments.

According to embodiments of the present disclosure, a battery system 100 with a fire extinguishing pump 20 is provided that can quickly and efficiently respond to a fire in a battery cell caused by venting gas being ejected and/or a thermal runaway to rapidly extinguish the fire with minimum loss in time. By using the venting gas to trigger the explosion of the explosive material, the battery system 100 does not require additional computational resources or additional sensors so that electronic circuitry is reduced and additional drag on processor's load of the BMS or other control units is avoided.

### SOME REFERENCE SYMBOLS

100 battery system
10 battery pack
12 battery cell
13 venting valve
14 housing
16 venting gas outlet
17 positive terminal
18 negative terminal
20 fire extinguishing pump
22 chamber
30 first portion
32 fire extinguisher material
34 outlet
35 movable barrier member
38 burst plate
40 second portion
42 explosive material
44 opening
50 explosion trigger system
52 venting gas
54 venting gas stream
60 venting pipe
62 opening
70 pyrotechnical fuse
80 mechanical pressure cartridge
82 movable member
84 spark generator
90 transport pipe system
92 transport pipe
94 release opening
P main transport pipe
P1, P2, P3 branched transport pipe
V1, V2, V3 valve
S1a, . . . , S1e; S2a, . . . , S2e; S3a, . . . , S3e sensor (e.g., temperature sensor)
110 control unit (e.g., controller)
S100 providing a battery system
S200 causing explosion of explosive material

What is claimed is

1. A battery system comprising:
a battery pack comprising a housing and a plurality of battery cells accommodated within the housing; and
a fire extinguishing pump comprising:
a chamber having a first portion and a second portion separated from each other by a movable barrier member between the first portion and the second portion;
a fire extinguisher material in the first portion;
an explosive material in the second portion; and
an outlet in the first portion of the chamber configured to release fire extinguisher material toward at least one of the battery cells; and
an explosion trigger system configured to cause the explosive material to explode in response to venting gas being ejected from at least one of the battery cells to move the movable barrier member to push at least some of the fire extinguisher material through the outlet.

2. The battery system as claimed in claim 1, wherein the explosion trigger system is configured to cause the explosive material in the fire extinguishing pump to explode in response to the venting gas being ejected from at least one of the battery cells in a thermal runaway event.

3. The battery system as claimed in claim 2, wherein the chamber has an opening in the second portion.

4. The battery system as claimed in claim 1, wherein the fire extinguishing pump is at a venting gas outlet of the housing so that the venting gas discharged through the venting gas outlet causes the explosive material to explode.

5. The battery system as claimed in claim 1, wherein the fire extinguishing pump is at a position inside the housing where a venting gas stream is formed when the venting gas is ejected so that venting gas causes the explosive material to explode.

6. The battery system as claimed in claim 1, wherein the explosion trigger system comprises a venting pipe extending from at least one of the plurality of battery cells to the fire extinguishing pump,
wherein the venting pipe comprises an opening so that the venting gases released from the at least one battery cell are transported to the fire extinguishing pump to cause the explosive material to explode.

7. The battery system as claimed in claim 6, wherein the opening in the venting pipe extends to above a venting valve of a corresponding one of the battery cells.

8. The battery system as claimed in claim 1, wherein the explosion trigger system comprises a pyrotechnical fuse extending from at least one of the battery cells to the fire extinguishing pump so that the venting gas causes a burning of the pyrotechnical fuse, which propagates to the fire extinguishing pump to cause the explosive material to explode.

9. The battery system as claimed in claim 8, wherein the pyrotechnical fuse extends to above a venting valve of a corresponding one of the battery cells.

10. The battery system as claimed in claim 1, wherein the explosion trigger system comprises:
a mechanical pressure cartridge comprising a movable member configured to be actuated in response to gas pressure above a reference pressure inside the housing; and
a spark generator, and
wherein the movable member is configured to mechanically actuate the spark generator to cause the explosive material to explode.

11. The battery system as claimed in claim 1, wherein the fire extinguishing pump comprises a burst plate at the outlet to contain the fire extinguisher material in the chamber, and
wherein the burst plate is configured to open in response to increased pressure of the fire extinguisher material.

12. The battery system as claimed in claim 1, wherein the outlet of the fire extinguishing pump is open to an interior of the housing so that the housing is at least partially flooded by the fire extinguisher material in response to the venting gas being ejected and/or a thermal runaway event.

13. The battery system as claimed in claim 1, further comprising a transport pipe system comprising a plurality of transport pipes, each having release openings,
wherein the transport pipes are connected to the outlet and extend to the plurality of battery cells so that the fire extinguisher material is supplied through the plurality of transport pipes to the plurality of battery cells in response to the venting gas being ejected and/or a thermal runaway event.

14. The battery system as claimed in claim 13, wherein the transport pipe system comprises:
a plurality of branched transport pipes having the release openings corresponding to ones of the battery cells and branched from a main transport pipe that is connected to the outlet; and
a plurality of valves, each provided in a respective one of the branched transport pipes, and
wherein the battery system further comprises:
a plurality of sensors, each associated with one or a subset from among the battery cells; and
a controller configured to:
detect the venting gas being ejected and/or a thermal runaway by at least one sensor from among the plurality of sensors;
identify the branched transport pipe associated to the at least one sensor detecting the venting gas being ejected and/or the thermal runaway; and
control the plurality of valves so that the fire extinguisher material is transported to the identified branched transport pipe.

15. A vehicle comprising the battery system as claimed in claim 1.

16. A method for operating a battery system, the method comprising the steps of:
providing the battery system as claimed in claim 1; and
causing the explosive material to explode in response to venting gas being ejected from at least one of the battery cells to move the movable barrier member to push at least some of the fire extinguisher material through the outlet toward at least one of the battery cells.
